(19) United States
(12) Patent Application Publication
(10) Pub. No.: US 2014/0028880 A1
(43) Pub. Date: Jan. 30, 2014

(54) IMAGE PROCESSING DEVICE, IMAGE PROCESSING METHOD, PROGRAM, AND IMAGING APPARATUS

(71) Applicant: Sony Corporation, Minato-ku (JP)

(72) Inventors: Yuki KAWAGUCHI, Tokyo (JP); Manabu Koiso, Kanagawa (JP); Nobuyuki Matsushita, Kanagawa (JP)

(21) Appl. No.: 13/908,078

(22) Filed: Jun. 3, 2013

(30) Foreign Application Priority Data
Jul. 24, 2012 (JP) 2012-163671

(51) Int. Cl. H04N 5/357; G06T 5/00

(52) U.S. Cl. CPC H04N 5/357; G06T 5/002
USPC 348/241

(57) ABSTRACT

There is provided an image processing device including a noise reduction intensity setting unit that sets an intensity of noise reduction for removing a predetermined noise component, and a noise reduction intensity correcting unit that corrects the intensity of noise reduction based on corrected data obtained according to an edge rate.

### BACKGROUND

The present disclosure relates to an image processing device, an image processing method, a program, and an imaging apparatus.

There are cases in which noise arising from characteristics of an image sensor or the like is superimposed on image data obtained from an imaging operation by an imaging apparatus. A process for removing such noise is generally called a noise reduction (NR (Noise Reduction)) process, and various techniques with regard to the noise reduction process have been proposed. For example, Japanese Unexamined Patent Application Publication No. 2008-177724 discloses a technology in which the presence or absence of an edge is determined, and when it is determined that there is an edge nearby, the noise reduction process is not performed in the vicinity of the edge.

### SUMMARY

The technology disclosed in Japanese Unexamined Patent Application Publication No. 2008-177724 has a problem in that, whereas noise can be removed while edges are left, the noise reduction process is not performed in the vicinity of edges, and thus, the S/N ratio (Signal to Noise Ratio) around the edges deteriorates.

Therefore, it is desirable to provide an image processing device, an image processing method, a program, and an imaging apparatus that can appropriately set an intensity of noise reduction according to an edge rate which indicates the level of edges.

According to an embodiment of the present disclosure, there is provided an image processing device including a noise reduction intensity setting unit that sets an intensity of noise reduction for removing a predetermined noise component, and a noise reduction intensity correcting unit that corrects the intensity of noise reduction based on corrected data obtained according to an edge rate.

According to an embodiment of the present disclosure, there is provided an image processing device including a noise reduction intensity setting unit that sets an intensity of noise reduction for removing a predetermined noise component, an edge rate computing unit that computes an edge rate based on a predetermined evaluation value, a noise reduction intensity correcting unit that corrects the intensity of noise reduction according to the edge rate, and a noise removing unit that removes a noise component. The predetermined evaluation value is set based on a value of an SAD between a first block set around a pixel of interest in a predetermined size and a second block set around a pixel different from the pixel of interest in a same size as the predetermined size. The noise removing unit removes a noise component based on the corrected intensity of noise reduction and the value of the SAD.

According to an embodiment of the present disclosure, there is provided an image processing method in an image processing device, the method including setting an intensity of noise reduction for removing a predetermined noise component, and correcting the intensity of noise reduction according to an edge rate.

According to an embodiment of the present disclosure, there is provided a program for causing a computer to execute an image processing method in an image processing device, the method including setting an intensity of noise reduction for removing a predetermined noise component, and correcting the intensity of noise reduction according to an edge rate.

According to an embodiment of the present disclosure, there is provided an imaging apparatus including an imaging unit, a noise reduction intensity setting unit that sets an intensity of noise reduction for removing a predetermined noise component, a noise reduction intensity correcting unit that corrects the intensity of noise reduction based on corrected data obtained according to an edge rate, and a noise removing unit that performs a noise reduction process on image data acquired through the imaging unit based on the corrected intensity of noise reduction.

According to at least one embodiment of the present disclosure described above, an intensity of noise reduction in a noise reduction process executed by a noise removing unit can be appropriately set.

### BRIEF DESCRIPTION OF THE DRAWINGS

FIG. 1 is a graph for describing the relationship between input levels and variances of noise of image data;

FIG. 2 is a graph for describing an example in which an intensity of noise reduction is changed according to input levels of image data;

FIG. 3 is a diagram for describing an example of a configuration of an image processing device according to a first embodiment of the present disclosure;

FIG. 4 is a table for describing an example of corrected data;

FIG. 5 is a graph for describing the example of corrected data;

FIG. 6 is a graph for describing another example of corrected data;

FIG. 7 is a flowchart showing an example of the flow of a process according to the first embodiment of the present disclosure;

FIG. 8 is a diagram for describing an example of a configuration of an image processing device according to a second embodiment of the present disclosure;

FIG. 9 is a diagram for describing an example of a computation method of an SAD value;

FIG. 10 is a diagram for describing an example of a process for computing the average value of a plurality of SAD values;

FIG. 11 is a flowchart showing an example of the flow of a process according to the second embodiment of the present disclosure;

FIG. 12 is a diagram for describing an example of a configuration of an image processing device according to a third embodiment of the present disclosure;

FIG. 13 is a flowchart showing an example of the flow of a process according to the third embodiment of the present disclosure;

FIG. 14 is a diagram for describing a modified example;

FIG. 15 is a diagram for describing another modified example; and

FIG. 16 is a diagram for describing still another modified example.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments of the present disclosure will be described in detail with reference to the appended drawings. It should be noted that description will be provided in the following order.

<1. First embodiment>

<2. Second embodiment>

<3. Third embodiment>

<4. Modified examples>

It also should be noted that the embodiments that will be described hereinbelow are specific examples preferable for the present disclosure, and do not limit the content of the present disclosure.

### 1. First Embodiment

### [Regarding the Relationship Between Variances of Noise and Input Levels of Image Data]

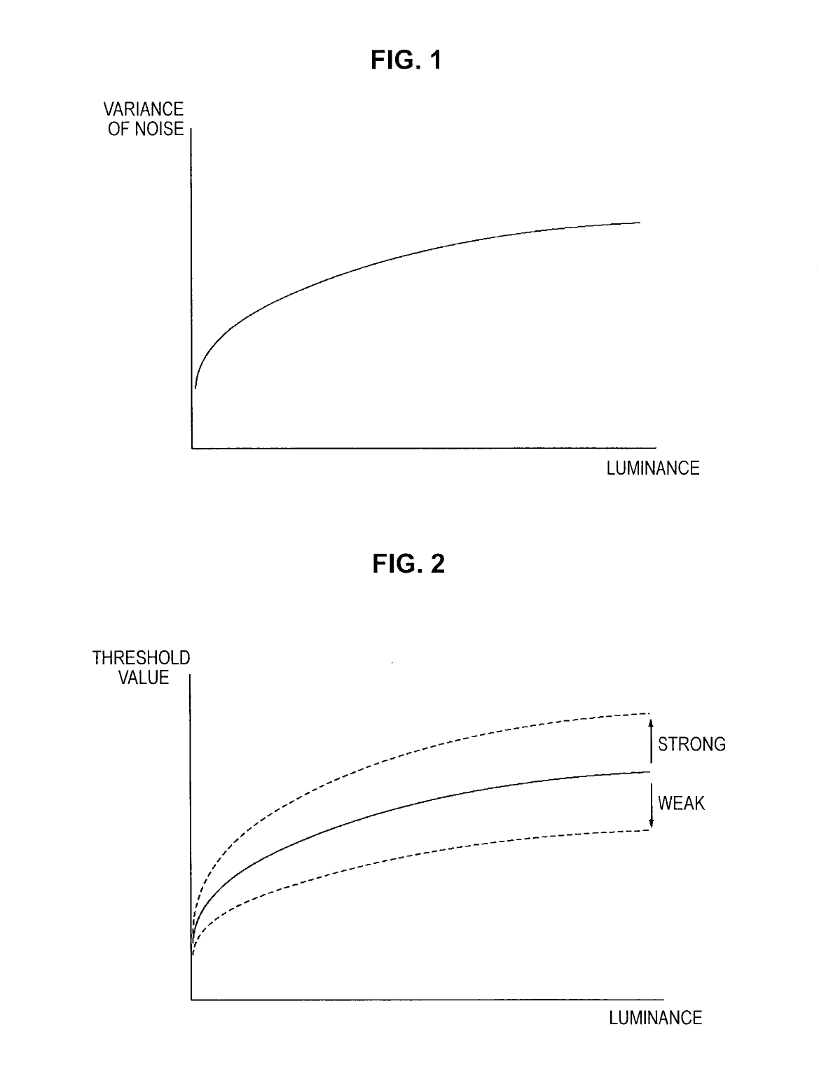

First, in order to make the present disclosure easy to understand, the relationship between input levels and variances of noise of image data will be described. Among components of noise generated in an imaging apparatus, there is noise that changes depending on input levels (luminance) of image data. FIG. 1 schematically shows variations of noise with respect to a luminance value x when a luminance value of a pixel is set to be x. As understood from FIG. 1, the variances of noise increases as the luminance value x increases. Here, if noise that does not depend on luminance of image data is included, the variance of the noise can be defined by, for example, Equation 1 below.

σ(x)=\sqrt{ax+b}

In Equation 1, a indicates a noise component that is mainly derived from optical shot noise of an image sensor having dependency on luminance, and that is substantially in proportion to the square root of luminance. b indicates a component of floor noise, such as thermal noise, that does not depend on luminance. x indicates a luminance value of a pixel. a and b are decided according to characteristics of an image sensor. Equation 1 is an example, and a variance of noise may be defined by a simplified equation below (for example, Equation 2), or other equations that stipulate noise components in more detail. Noise can be deemed to be normally distributed in a certain level or lower level of sensitivity.

σ(x)=a\sqrt{x}+b

Noise that has dependency on luminance can be effectively removed by changing a threshold value in accordance with a predicted variance of the noise. Using σ(x) computed in Equation 1, the threshold value Th of each pixel is computed with Equation 3.

Th=S*σ(x)

S in Equation 3 is an intensity adjusting value, and a default value thereof is set before, for example, imaging apparatuses are released. The intensity adjusting value S may be variable. For example, the intensity adjusting value S may be changed according to a setting of a user. When a user sets an intensity of noise reduction to be high, the intensity adjusting value S increases, and when the user sets the intensity of noise reduction to be low, the intensity adjusting value S decreases.

The threshold value computed with Equation 3 is set for a noise removing unit that performs a noise reduction process. As the noise removing unit, an c (epsilon) filter, or a wavelet filter is exemplified. As shown in FIG. 2, the intensity of noise reduction can be elevated by increasing the threshold value, and the intensity of noise reduction can lowered by decreasing the threshold value. With the noise reduction process using the threshold values computed for each pixel, noise can be effectively removed.

If a threshold value Th is computed referring to image data on which noise is superimposed, the accuracy of the threshold value Th may deteriorate. As a result, noise reduction with an improper intensity may be applied to data. Particularly, when noise reduction with an improper intensity is applied in the vicinity of an edge in image data, a problem of losing edges arises, and the quality of an image thereby drastically deteriorates. Thus, in the present disclosure, the intensity of noise reduction in edge regions in an image is more properly adjusted by correcting a threshold value Th according to an edge rate. Hereinafter, a specific example with regard to the content of the present disclosure will be described.

### [Configuration of an Image Processing Device]

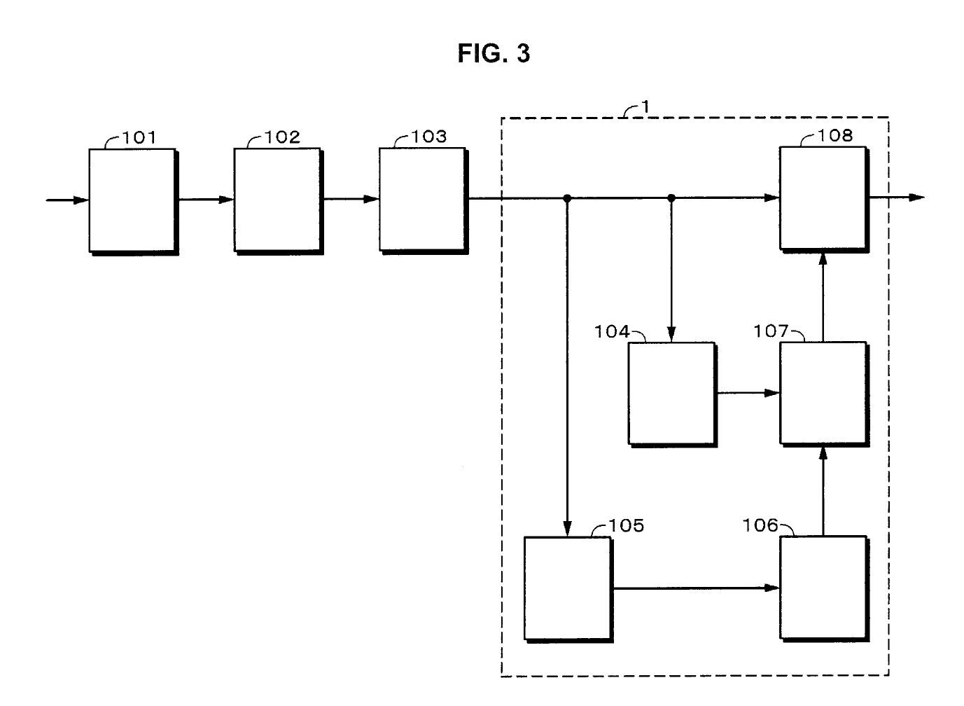

FIG. 3 is a diagram for describing a configuration of an image processing device according to a first embodiment of the present disclosure. The image processing device 1 is built in, for example, an imaging apparatus. Reference numerals 101, 102, and 103 respectively indicate an image sensor, an analog front-end (AFE), and a buffer memory included in the imaging apparatus. The latter part of the buffer memory 103 is connected to the image processing device 1. The buffer memory 103 stores image data of one frame or in a size necessary for processing by the image processing device 1, and on the image data stored in the buffer memory 103, a noise reduction process is performed by the image processing device 1.

The image processing device 1 is configured to include, for example, a noise reduction intensity setting unit 104, an edge rate computing unit 105, a corrected data computing unit 106, a noise reduction intensity correcting unit 107, and a noise removing unit 108. In the configuration, a part thereof may be included in the configuration of the imaging apparatus, or a configuration different from the exemplified configuration may be added to the image processing device 1.

It should be noted that, although not shown in the drawing, the imaging apparatus may be configured to have a display device such as an LCD (Liquid Crystal Display), a memory such as a hard disk, or a USB (Universal Serial Bus), or a system controller that controls each unit of the imaging apparatus. After a well-known digital image process is performed on image data that has undergone a process by the image processing device 1, the image data is displayed on the display device, or stored in the memory.

Each of the units will be described in detail. Optical images from a subject are condensed using lenses and a diaphragm (omitted in the drawing) of the imaging apparatus. The amount of light of the optical images is adjusted by the diaphragm. A condensed optical image is photoelectrically converted by the image sensor 101, thereby generating analog image data that includes electric signals. The image sensor 101 is configured by a CCD (Charge Coupled Device) sensor, a CMOS (Complementary Metal Oxide Semiconductor) sensor, or the like. The image sensor 101 has RGB color filters in, for example, a Bayer array.

The AFE 102 appropriately adjusts the SN (Signal to Noise) ratio by performing, for example, a CDS (Correlated Double Sampling) process on the analog image data supplied from the image sensor 101. Further, the AFE 102 controls a gain by performing AGC (Automatic Gain Control). In addition, the AFE 102 performs an A/D (Analog to Digital) conversion process on the analog image data so as to generate digital image data. The AFE 102 outputs the generated digital image data. The digital image data output from the AFE 102 is supplied to the buffer memory 103.

The buffer memory 103 is a memory storing the digital image data supplied from the AFE 102. The buffer memory 103 stores image data in an amount necessary for the image processing device 1 to perform subsequent processes. For example, a pixel is set as a pixel of interest, and then image data with a predetermined area including the pixel of interest at the center is supplied to the buffer memory 103. The buffer memory 103 may store image data, for example, in a size of one frame. The image processing device 1 may be designed to perform a process for a predetermined area of image data of one frame. The image data output from the buffer memory 103 is supplied to the noise reduction intensity setting unit 104, the edge rate computing unit 105, and the noise removing unit 108.

Each of the units of the image processing device 1 will be described. The noise reduction intensity setting unit 104 computes luminance information that serves as a reference (hereinafter, appropriately referred to as reference luminance information) using a luminance value of a pixel of interest or a luminance value of a pixel around the pixel of interest in addition to the luminance value of the pixel of interest. The noise reduction intensity setting unit 104 computes a variance σ(x) of noise using the reference luminance information. A variance of noise can be computed with Equation 1 described above. x in Equation 1 corresponds to reference luminance information. a and b in Equation 1 are values based on the characteristics of the image sensor 101, and known values for the imaging apparatus. The noise reduction intensity setting unit 104 retains a and b which are the known values in a memory, or the like not shown in the drawing. Thus, the noise reduction intensity setting unit 104 can compute the variance σ(x) of noise using Equation 1.

The noise reduction intensity setting unit 104 multiplies a predetermined intensity adjusting value S by the variance σ(x) of noise to compute a threshold value Th. It should be noted that the threshold value Th computed by the noise reduction intensity setting unit 104 is appropriately called a threshold value Th1. The intensity of noise reduction is set using the threshold value Th1. The intensity of noise reduction set by the noise reduction intensity setting unit 104 is supplied to the noise reduction intensity correcting unit 107.

The edge rate computing unit 105 computes an edge rate of the pixel of interest referring to the pixel of interest and distribution of luminance of pixels around the pixel of interest. The edge rate indicates the degree of an edge, and for example, when the edge rate is low, the pixel of interest is a pixel of a flat part of an image, and when the edge rate is high, the pixel of interest is a pixel on the edge.

A method for computing the edge rate in the first embodiment is not particularly limited. For example, the differences between the luminance value of a pixel of interest and the luminance values of peripheral pixels are computed, and an edge rate may be thereby decided according to the average value thereof. For example, a one-dimensional or two-dimensional differential filter may be applied to a region with a predetermined size (for example, 3×3 pixels) around the pixel of interest so as to decide the result as an edge rate. The edge rate computed by the edge rate computing unit 105 is supplied to the corrected data computing unit 106.

The corrected data computing unit 106 computes corrected data according to the edge rate supplied from the edge rate computing unit 105. An example of computation of the corrected data will be described later.

The noise reduction intensity correcting unit 107 corrects the intensity of noise reduction set by the noise reduction intensity setting unit 104 based on corrected data supplied from the corrected data computing unit 106. The noise reduction intensity correcting unit 107 multiplies the corrected data by, for example, the threshold value Th1 so as to compute a threshold value Th2 that is the final intensity of noise reduction, thereby correcting the intensity of noise reduction. The noise reduction intensity correcting unit 107 supplies the threshold value Th2 to the noise removing unit 108.

The noise removing unit 108 performs a noise reduction process to remove noise based on the threshold value Th2. The noise removing unit 108 is configured by, for example, an ε filter. The ε filter is a two-dimensional filter, and has a function of performing a non-linear filtering process on the input image data using the threshold value Th2. It should be noted that the noise removing unit 108 is not limited to the ε filter as long as the unit can vary the intensity of noise reduction according to certain set values such as threshold values. The noise removing unit 108 may be another filter, for example, a wavelet filter, or the like. The noise removing unit 108 outputs image data that has undergone the noise reduction process.

On the image data output from the noise removing unit 108, a camera signal process such as a demosaicing, AF (Auto Focus), AE (Auto Exposure), or AWB (Auto White Balance) process is performed. The image data that has undergone the camera signal process is supplied to, for example, the display device, and then an image is displayed on the image device based on the image data. The image data that has undergone the camera signal process may be compressed in a predetermined format, and the compressed image data may be stored in the memory.

### [Operation Of the Image Processing Device]

An example of an operation of the image processing device 1 will be described. It has been described that the buffer memory 103 stores image data that includes a pixel set as a pixel of interest and a block of 3 (pixels)×3 (pixels) around the pixel of interest.

The noise reduction intensity setting unit 104 sets the reference luminance information x using the image data of the block having 3×3 pixels. With regard to the reference luminance information x, for example, the luminance value of the pixel of interest is set as the reference luminance information x as it is. In order to reduce the influence of noise, the average value or the center value of the luminance values of nine pixels in the block may be set as the reference luminance information x. The noise reduction intensity setting unit 104 computes the variance σ(x) of noise based on Equation 1 using the reference luminance information x and a and b which are known values. Then, the noise reduction intensity setting unit 104 computes the threshold value Th1 based on the variance σ(x) of noise based on Equation 3. The threshold value Th1 is supplied to the noise reduction intensity correcting unit 107.

In parallel with the process performed by the noise reduction intensity setting unit 104, the edge rate computing unit 105 computes an edge rate. The edge rate is supplied to the corrected data computing unit 106. The corrected data computing unit 106 computes corrected data according to the edge rate, and then supplies the computed corrected data to the noise reduction intensity correcting unit 107. The noise reduction intensity correcting unit 107 corrects the threshold value Th1 based on the corrected data, and computes the threshold value Th2 that is the final intensity of noise reduction. The threshold value Th2 is supplied to the noise removing unit 108. The noise removing unit 108 performs a noise reduction process based on the threshold value Th2.

When the process performed on a pixel of interest ends, a new pixel of interest is set, and the same process as described above is repeated. Pixels of interest are set in order of, for example, raster scanning. With the process in the image processing device 1, image data in which noise is removed or reduced is obtained.

### [Example of Corrected Data]

An example of the corrected data computed by the corrected data computing unit 106 will be described. The corrected data computing unit 106 classifies a pixel of interest into, for example, any one of an edge part, a detail part (part with fine patterns, or the like), and a flat part (part in which an image rarely changes) according to the edge rate supplied from the edge rate computing unit 105. Each classification is associated with a magnification that is an example of the corrected data. A magnification is set to be, for example, a predetermined value between 0 and 1.

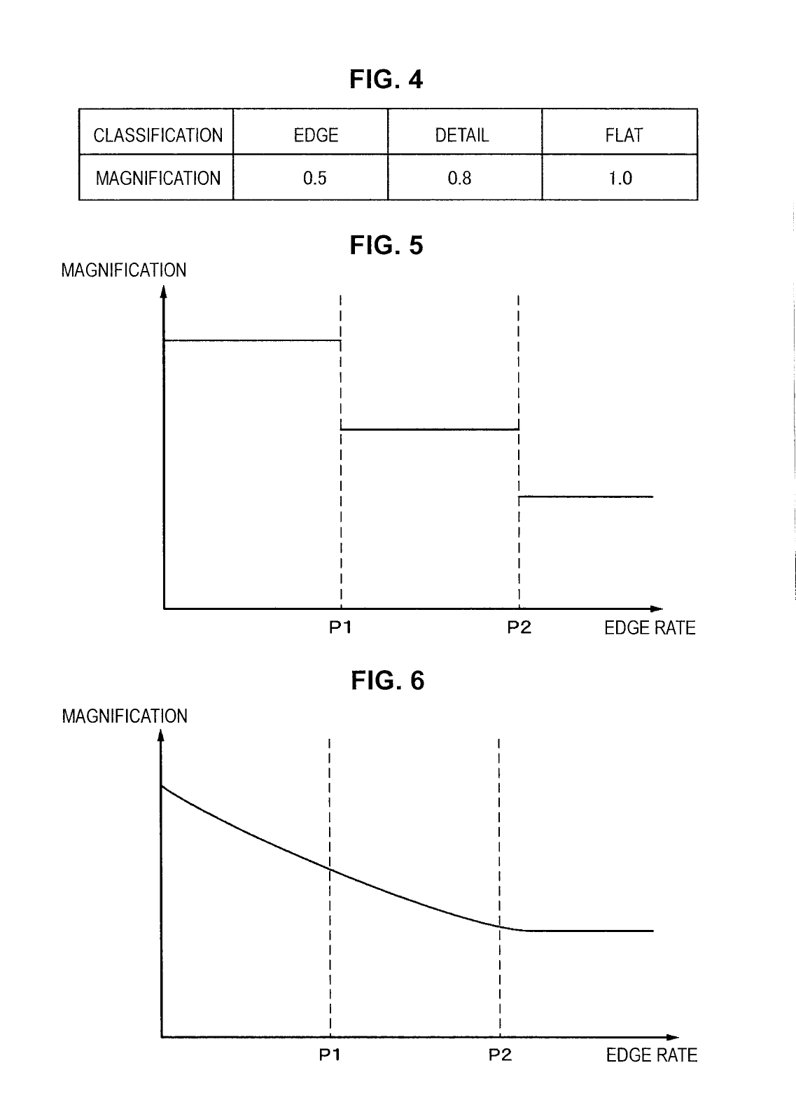

As exemplified in FIG. 4, when the edge rate is a value in the range from 0 to a value that is lower than or equal to a predetermined value P1, for example, a pixel thereof is classified into a flat part. The classification category of the edge part is associated with, for example, a magnification of 1.0. When the edge rate is greater than the predetermined value P1 and lower than or equal to a predetermined value P2, the pixel thereof is classified into a detail part. The detail part is associated with, for example, a magnification of 0.8. When the edge rate is greater than the predetermined value P2, the pixel thereof is classified into an edge part. The edge part is associated with a magnification of 0.5.

The corrected data computing unit 106 decides a magnification according to classification categories as corrected data. It should be noted that a pixel does not necessarily have to be classified into an edge part, or the like, and a magnification may be decided according to the magnitude of the edge rate as shown in FIG. 5. As shown in FIG. 6, the magnification may be set to substantially linearly change up to a predetermined edge rate (for example, the predetermined value P2), and may be set to a predetermined value (for example, 0.5) for a predetermined edge rate or higher. The magnification may be computed by performing a predetermined arithmetic operation on an edge rate.

The corrected data computing unit 106 supplies the decided magnification to the noise reduction intensity correcting unit 107. The noise reduction intensity correcting unit 107 multiplies the threshold value Th1 by a predetermined magnification so as to compute the threshold value Th2.

Since the magnification decreases as the edge rate increases, the threshold value Th2 decreases. In other words, the intensity of noise reduction decreases. In this manner, since correction is performed so that the intensity of noise reduction decreases as the edge rate increases, noise can be effectively removed while edges are maintained. Furthermore, even when the edge rate is high, a noise reduction with predetermined intensity is executed, and thus noise in the vicinity of edges can be removed. The intensity of noise reduction which has been set so as to effectively remove noise components that have dependency on luminance can be corrected to an appropriate intensity of noise reduction so that edges are maintained.

### [Example of Process Flow]

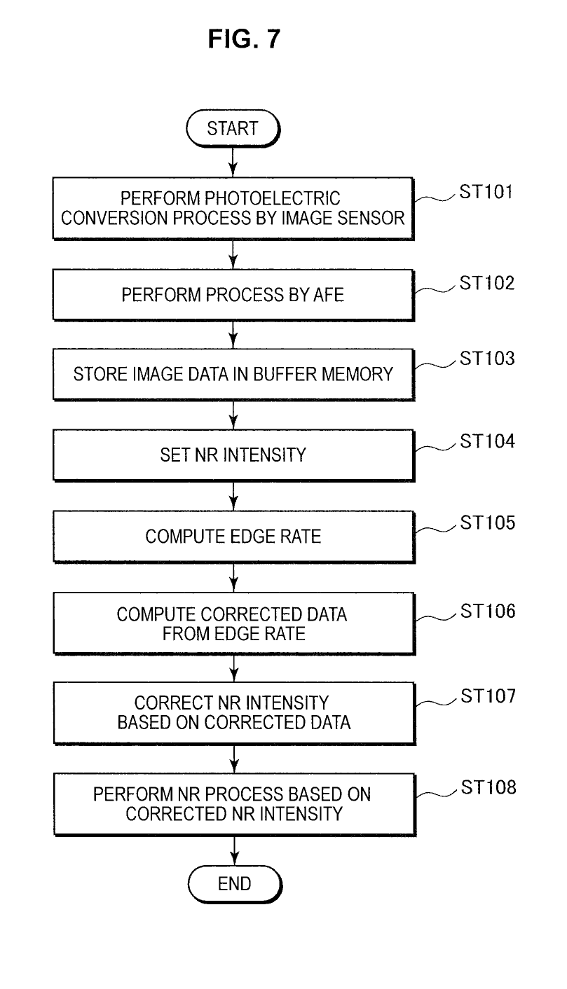

An example of the flow of the process performed by the image processing device 1 according to the first embodiment will be described with reference to the flowchart of FIG. 7. It should be noted that part of the process will be performed by the image sensor or the AFE of the imaging apparatus. In Step ST101, the image sensor 101 executes a photoelectric conversion process to obtain analog image data. Then, the process proceeds to Step ST102.

In Step ST102, the AFE 102 performs a process on the analog image data. From the process by the AFE 102, digital image data is obtained. Then, the process proceeds to Step ST103.

In Step ST103, the digital image data in a size necessary for processes is stored in the buffer memory 103. For example, image data of block in the size of 3×3 pixels including a pixel of interest at the center is stored in the buffer memory 103. Of course, the size of the block is not limited to 3×3 pixels, and can be set to be an arbitrary size. Then, the process proceeds to Step ST104.

In Step ST104, an intensity of noise reduction is set by the noise reduction intensity setting unit 104. As described above, the noise reduction intensity setting unit 104 sets reference luminance information, and computes a variance σ(x) of noise using the reference luminance information, or the like. Then, the variance of noise is multiplied by a predetermined intensity adjusting value S to compute a threshold value Th1. The threshold value Th1 is set as the intensity of noise reduction. Then, the process proceeds to Step ST105.

In Step ST105, an edge rate is computed by the edge rate computing unit 105. The computed edge rate is supplied to the corrected data computing unit 106. Then, the process proceeds to Step ST106.

In Step ST106, corrected data is computed (decided) by the corrected data computing unit 106 according to the edge rate. The corrected data is supplied to the noise reduction intensity correcting unit 107. The process proceeds to Step ST107.

In Step ST107, the noise reduction intensity correcting unit 107 corrects the intensity of noise reduction based on the corrected data. The noise reduction intensity correcting unit 107 multiplies, for example, a predetermined magnification that is an example of the corrected data by the threshold value Th1 to compute a threshold value Th2, and accordingly corrects the intensity of noise reduction. The threshold value Th2 is supplied to the noise removing unit 108. Then, the process proceeds to Step ST108.

In Step ST108, the noise removing unit 108 executes a noise reduction process based on the threshold value Th2 that is the corrected intensity of noise reduction. Although not shown in the drawing, a new pixel of interest is set after Step ST108, and the processes from Step ST104 to Step ST108 are repeated. When processes on all pixels in the image data are completed, the process ends.

In the flow of the process exemplified in FIG. 7, some processes may be performed in parallel. For example, the processes of Step ST104, Step ST105, and Step ST106 may be performed in parallel.

### 2. Second Embodiment

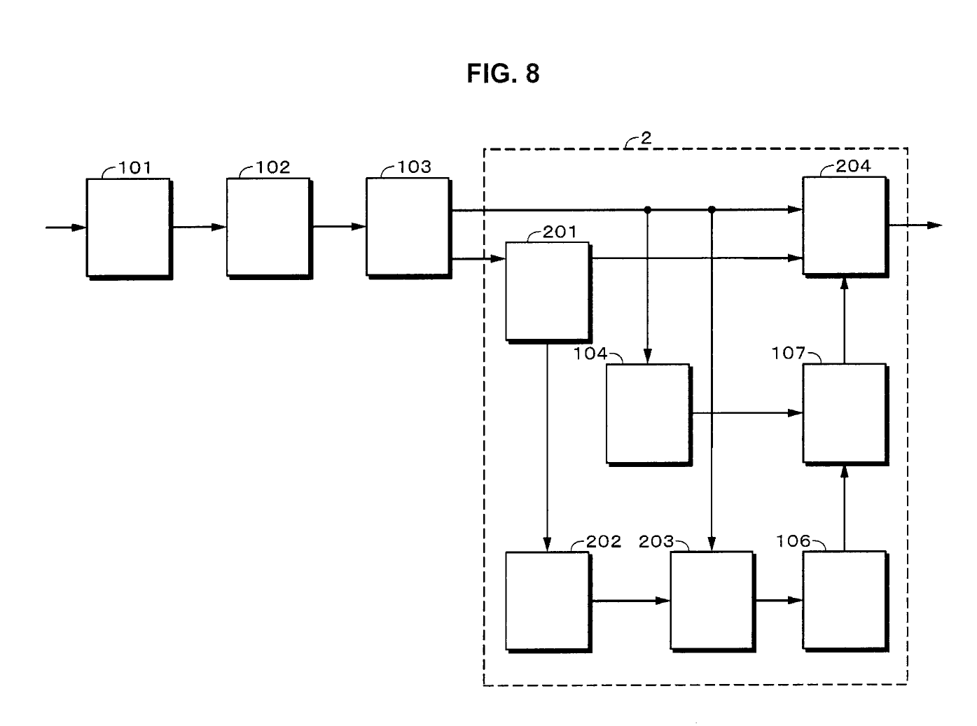

Next, a second embodiment of the present technology will be described. An image processing device 2 according to the second embodiment is built in, for example, an imaging apparatus in the same manner as the image processing device 1. FIG. 8 is a diagram for describing an example of a configuration of the image processing device 2. It should be noted that, in FIG. 8, the same reference numerals are given to the same portions as or the corresponding portions to those of the image processing device 1. Overlapping description of constituent elements to which the same reference numerals are given will be appropriately omitted.

The image processing device 2 is configured to include the noise reduction intensity setting unit 104, the corrected data computing unit 106, the noise reduction intensity correcting unit 107, a SAD (Sum of Absolute Difference) computing unit 201, a SAD average computing unit 202, an edge rate computing unit 203, and a noise removing unit 204. Among the constituent elements, some may be included in the imaging apparatus, or constituent elements different from the exemplified ones may be added to the image processing device 2.

The SAD computing unit 201 is connected to the buffer memory 103, and computes, for example, a plural number of SAD values, each of which is an example of a predetermined evaluation value based on image data stored in the buffer memory 103. An example of computation of a SAD value will be described later. The SAD computing unit 201 is connected to the SAD average computing unit 202, and the plurality of SAD values are supplied from the SAD computing unit 201 to the SAD average computing unit 202. The SAD computing unit 201 is further connected to the noise removing unit 204, and one or a plurality of SAD values are supplied from the SAD computing unit 201 to the noise removing unit 204.

The SAD average computing unit 202 computes the average value of the SAD values supplied from the SAD computing unit 201. The average value of the computed SAD values is supplied to the edge rate computing unit 203.

The edge rate computing unit 203 computes an edge rate according to the average value of the SAD values supplied from the SAD average computing unit 202. For example, a table in which the average value of the SAD values and the edge rate corresponding to the average value of the SAD values are described is retained, and the edge rate computing unit 203 computes the edge rate according to the average value of the SAD values by reading the table. The edge rate may be computed by performing a predetermined arithmetic operation on the average value of the SAD values.

It should be noted that the edge rate computing unit 203 is connected to a line between the buffer memory 103 and the noise removing unit 204, and image data stored in the buffer memory 103 is configured to be supplied to the edge rate computing unit 203.

The noise removing unit 204 performs a noise reduction process based on an intensity of noise reduction corrected by the noise reduction intensity correcting unit 107. The noise removing unit 204 is configured by, for example, an E filter in the same manner as the noise removing unit 108.

The noise removing unit 204 further performs the noise reduction process using one or a plurality of SAD values supplied from the SAD computing unit 201. Various techniques have been proposed with regard to the noise reduction process using SAD values. As an example of the relevant techniques, a technique disclosed in Japanese Unexamined Patent Application Publication No. 2009-105533 is exemplified. The document describes a technique in which a plurality of images are captured at a high speed, a summing rate of the plurality of images is decided based on SAD values, and the plurality of images are combined according to the summing rate, thereby reducing noise. The noise removing unit 204 further performs a noise reduction process based on the final intensity of noise reduction on, for example, images obtained by overlapping a plurality of images.

### [Operation of Image Processing Device]

An example of an operation of the image processing device 2 will be described. Description will be provided on the assumption that the buffer memory 103 stores, for example, image data of a block in the size of 7×7 pixels.

The noise reduction intensity setting unit 104 sets a predetermined pixel in image data stored in the buffer memory 103 as a pixel of interest. The noise reduction intensity setting unit 104 sets reference luminance information x. An example of setting the reference luminance information x is as described above.

The noise reduction intensity setting unit 104 computes a variance σ(x) of noise based on Equation 1 using the reference luminance information x and a and b which are known values, and computes a threshold value Th1 based on the variance σ(x) of noise. The threshold value Th1 is supplied to the noise reduction intensity correcting unit 107.

The SAD computing unit 201 computes a plurality of SAD values using the image data of the block in the size of 7×7 pixels stored in the buffer memory 103. The plurality of SAD values are supplied to the SAD average computing unit 202. The SAD average computing unit 202 computes the average value of the SAD values. The average value of the SAD values is supplied to the edge rate computing unit 203. The edge rate computing unit 203 computes an edge rate according to the average value of the SAD values. The computed edge rate is supplied to the corrected data computing unit 106.

The corrected data computing unit 106 generates corrected data according to the edge rate. The corrected data is supplied to the noise reduction intensity correcting unit 107. The noise reduction intensity correcting unit 107 corrects the threshold value Th1 based on the corrected data, and computes the threshold value Th2 that is the final intensity of noise reduction. The threshold value Th2 is supplied to the noise removing unit 204. The noise removing unit 204 performs a noise reduction process using the SAD values and the threshold value Th2.

When a process on a pixel of interest ends, a new pixel of interest is set, and the same process as that described above is repeated. Pixels of interest are set in order of, for example, raster scanning. From the process performed in the image processing device 2, image data of which noise is removed or reduced is obtained.

### [Regarding SAD]

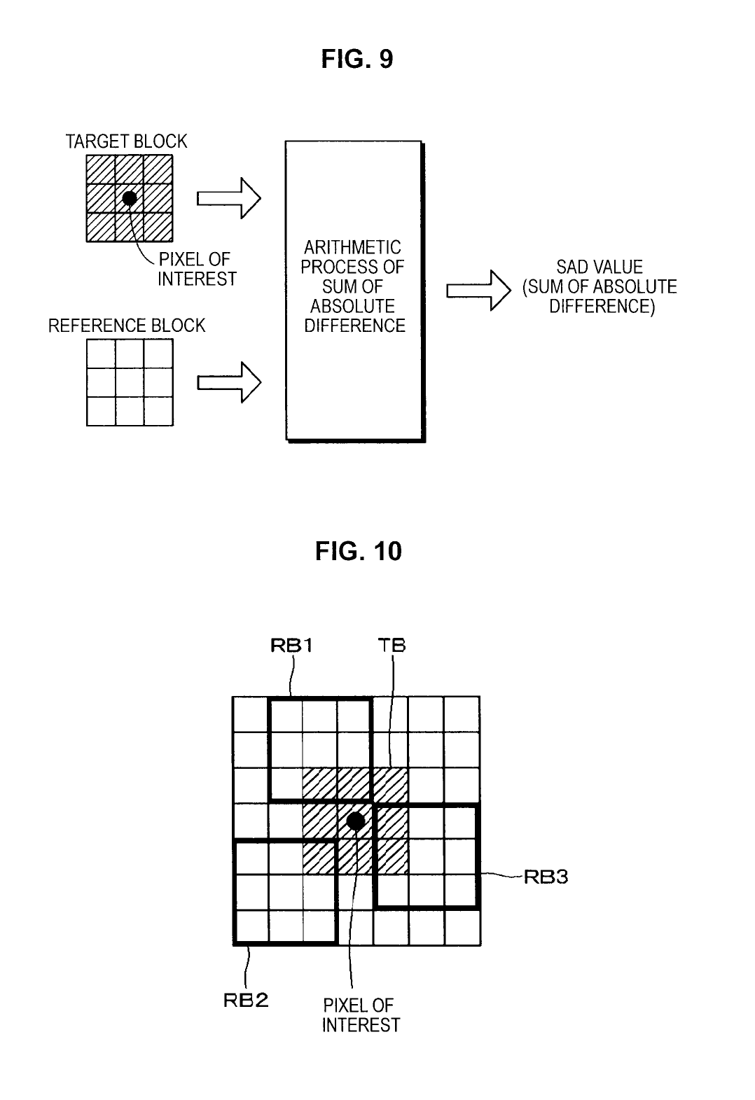

The SAD value computed by the SAD computing unit 201 will be described. FIG. 9 is a diagram for describing an example of computing an SAD value. A predetermined pixel in image data stored in the buffer memory 103 is set as a pixel of interest. A block in the size of 3×3 pixels including the pixel of interest at the center (hereinafter, appropriately referred to as a target block) is set. In the image data stored in the buffer memory 103, a block in the same size as the target block having a pixel different from the pixel of interest at the center (hereinafter, appropriately referred to as a reference block) is set.

The sum of the absolute values of the differences of the luminance values of pixels in the target block and the luminance values of corresponding pixels in the reference block (hereinafter, appropriately referred to as the sum of absolute difference values) for all of the pixels in the blocks is calculated. This sum of absolute difference values corresponds to an SAD value.

A plurality of SAD values are obtained by changing the reference block. For example, it is assumed that the image data of the block in the size of 7×7 pixels shown in FIG. 10 is stored in the buffer memory 103. A predetermined pixel of the image data is set as a pixel of interest, and a target block TB in the size of 3×3 pixels is set around the pixel of interest. It should be noted that, when a pixel of interest is positioned at an end of an image, the size of the target block TB may be appropriately adjusted.

In the block of 7×7 pixels, a plurality of reference blocks are set. For example, three reference blocks RB (a reference block RB1, a reference block RB2, and a reference block RB3) are set. It should be noted that the number and positions of reference blocks can be arbitrarily changed.

The SAD computing unit 201 performs an arithmetic operation process of SAD values on the target block TB and the three reference blocks to compute three SAD values. The three SAD values are supplied to the SAD average computing unit 202. The SAD average computing unit 202 computes the average value of the three SAD values. The average value of the three SAD values is supplied to the edge rate computing unit 203.

Here, a high average value of the SAD values means that the differences of the blocks are large, in other words, that there is a high possibility of pixels being an edge. Thus, the edge rate computing unit 203 computes an edge rate so that, as the average value of the SAD values increases, the edge rate increases.

A magnification is computed by the corrected data computing unit 106 so that, as the edge rate increases, the magnification that is an example of corrected data decreases. The noise reduction intensity correcting unit 107 corrects an intensity of noise reduction according to the magnification computed by the corrected data computing unit 106. In other words, the intensity of noise reduction is corrected so that, as the edge rate increases, the intensity of noise reduction decreases. Based on the corrected intensity of noise reduction, a noise reduction process is performed by the noise removing unit 204. In other words, noise can be effectively removed or reduced while the edges are maintained.

In this manner, the image processing device 2 according to the second embodiment computes the edge rate using the SAD values, each of which is an example of an evaluation value. The edge rate can be computed with high accuracy by computing the edge rate based on the average of the plurality of SAD values.

Furthermore, in the imaging apparatus, or the like, when any process in which an SAD value is used (the process is not necessarily limited to a noise reduction process but may be a process for generating a depth map or a process for obtaining a motion vector) is performed, the SAD value can be used in a process for computing an edge rate, and it is not necessary to newly add a configuration for computing the SAD value to the process. For this reason, an effective noise reduction process can be performed without increasing the size of a circuit.

### [Flow of Process]

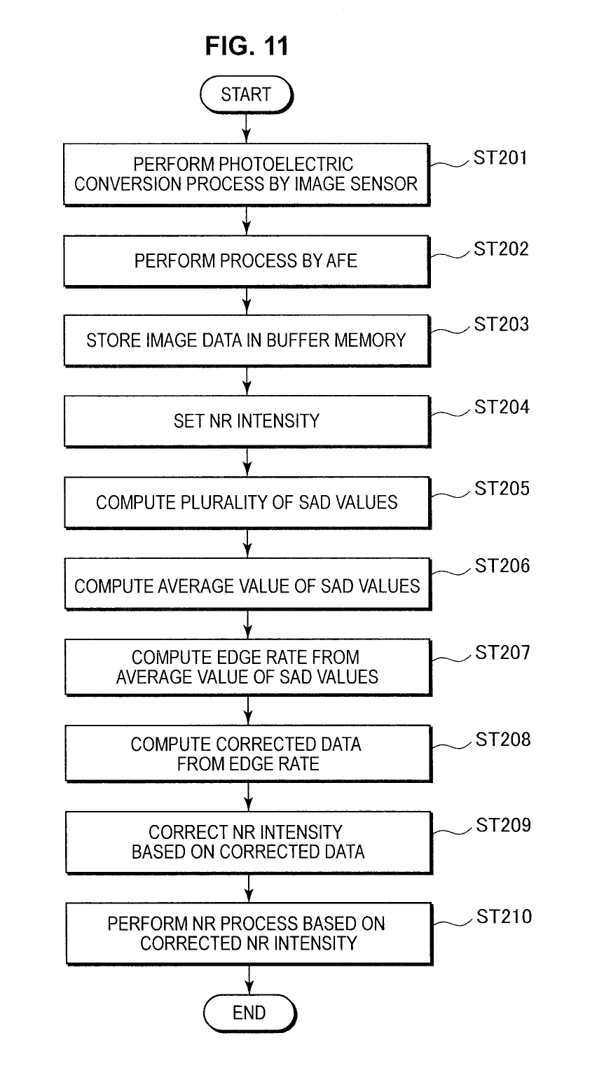

An example of the flow of the process performed in the image processing device 2 according to the second embodiment will be described with reference to the flowchart shown in FIG. 11. It should be noted that part of the process is performed by the image sensor or the AFE of the imaging apparatus. In Step ST201, the image sensor 101 performs a photoelectric conversion process to acquire analog image data. Then, the process proceeds to Step ST202.

In Step ST202, the AFE 102 performs a process on the analog image data. From the process performed by the AFE 102, digital image data is obtained. Then, the process proceeds to Step ST203.

In Step ST203, the digital image data in the size necessary for the process is stored in the buffer memory 103. The image data of a block in the size of 7×7 pixels is stored in the buffer memory 103. Of course, the block size is not limited to the size of 7×7 pixels, and can be set to be an arbitrary size. Then, the process proceeds to Step ST204.

In Step ST204, the intensity of noise reduction is set by the noise reduction intensity setting unit 104. As described above, the noise reduction intensity setting unit 104 sets the reference luminance information, and computes the variance σ(x) of noise using the reference luminance information, or the like. Then, the variance σ(x) of noise is multiplied by a predetermined intensity adjusting value S to compute a threshold value Th1. The threshold value Th1 is set as the intensity of noise reduction. Then, the process proceeds to Step ST205.

In Step ST205, a plurality of SAD values are computed by the SAD computing unit 201. The plurality of SAD values are supplied to the SAD average computing unit 202. Then, the process proceeds to Step ST206.

In Step ST206, the average value of the SAD values is computed by the SAD average computing unit 202. The average value of the SAD values is supplied to the edge rate computing unit 105. Then, the process proceeds to Step ST207.

In Step ST207, an edge rate is computed by the edge rate computing unit 203. The edge rate computing unit 203 computes the edge rate based on the average of the SAD values. The edge rate is supplied to the corrected data computing unit 106. Then, the process proceeds to Step ST208.

In Step ST208, corrected data is computed by the corrected data computing unit 106. The corrected data computing unit 106 computes a magnification according to the edge rate, and then supplies information indicating the computed magnification to the noise reduction intensity correcting unit 107. Then, the process proceeds to Step ST209.

In Step ST209, the intensity of noise reduction is corrected based on the corrected data. The noise reduction intensity correcting unit 107 corrects the intensity of noise reduction by multiplying the threshold value Th1 by the predetermined magnification to compute a threshold value Th2 that is the final intensity of noise reduction. The threshold value Th2 is supplied to the noise removing unit 204. Then, the process proceeds to Step ST210.

In Step ST210, the noise removing unit 210 performs a noise reduction process based on the threshold value Th2 that is the corrected intensity of noise reduction. Although not shown in the drawing, after Step ST210, a new pixel of interest is set, and the processes from Step ST204 to Step ST210 are repeated. When the processes are completed for all pixels of the image data, the process ends.

In the flow of the process exemplified in FIG. 11, some processes may be performed in parallel. For example, the processes of Step ST204, Step ST205, Step ST206, Step ST207, and Step ST208 may be performed in parallel.

### 3. Third Embodiment

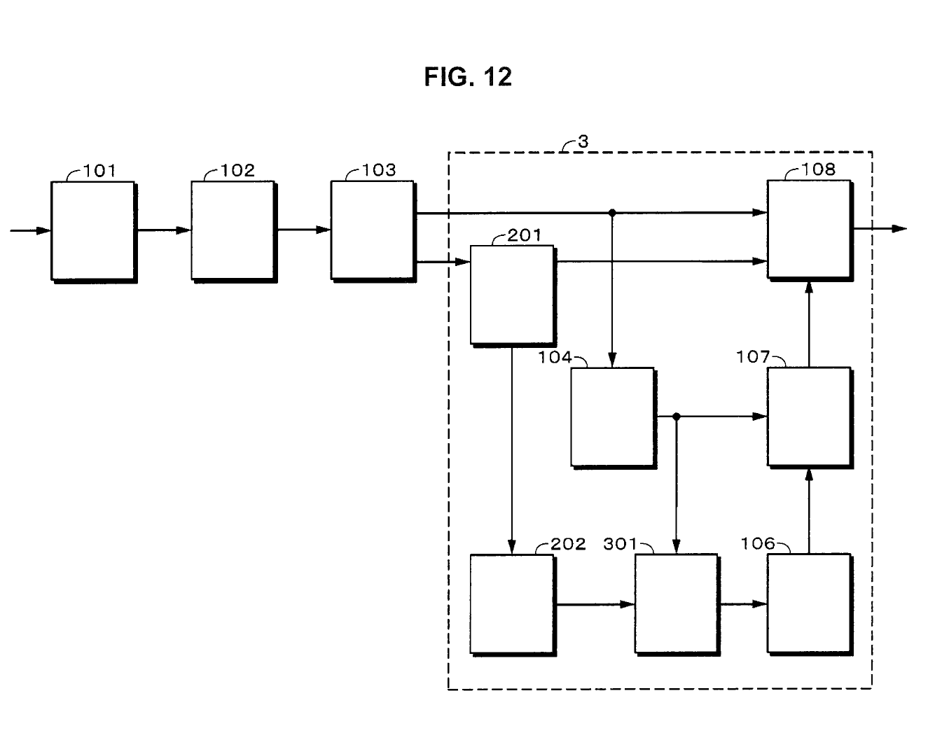

Next, a third embodiment will be described. An image processing device 3 according to the third embodiment is built in, for example, an imaging apparatus in the same manner as the image processing device 2. FIG. 12 is a diagram for describing an example of a configuration of the image processing device 3. It should be noted that, in FIG. 12, the same reference numerals are given to the same portions as or the corresponding portions to those in the image processing device 2. Overlapping description of constituent elements to which the same reference numerals are given will be appropriately omitted.

The image processing device 3 is configured substantially in the same manner as the image processing device 2. Differences from the image processing device 2 are that an edge rate computing unit 301 is provided instead of the edge rate computing unit 105, and that the edge rate computing unit 301 is connected between the noise reduction intensity setting unit 104 and the noise reduction intensity correcting unit 107. In other words, the image processing device 3 is configured such that a threshold value Th1 is supplied from the noise reduction intensity setting unit 104 to the edge rate computing unit 301.

As described above, in the image processing device 2, the edge rate is designed to be computed according to the average value of the SAD values. Meanwhile, as luminance of a flat part in image data for which an SAD value is computed increases, the SAD value tends to increase. This is because the size of optical shot noise arising in the image sensor 101 increases substantially in proportion to the square of luminance. In other words, since there is a case in which the amplitude of noise is high in a location having high luminance, an SAD value increases even if the location is originally not an edge or in the vicinity of an edge. For this reason, accuracy of determining an edge rate is lowered. Thus, in the third embodiment, a process for normalizing the average of SAD values is performed for the purpose of eliminating dependency of noise on luminance.

For example, the edge rate computing unit 301 normalizes the average value of SAD values by dividing the average value of the SAD values by the threshold value Th1 that includes a component of the square of luminance. According to the result of the normalization process, an edge rate is computed. Since other processes are the same as those of the image processing device 2, overlapping description will be omitted.

In the normalization process, the threshold value Th1 that is computed to set an intensity of noise reduction is used. In other words, an increase in the scale of a circuit or the like can be prevented without adding a new configuration for computing a parameter necessary for the normalization process. Furthermore, a decrease in the intensity of noise reduction in a location, for example, that is not an edge can be prevented since accuracy in computation of an edge rate improves.

### [Flow of Process]

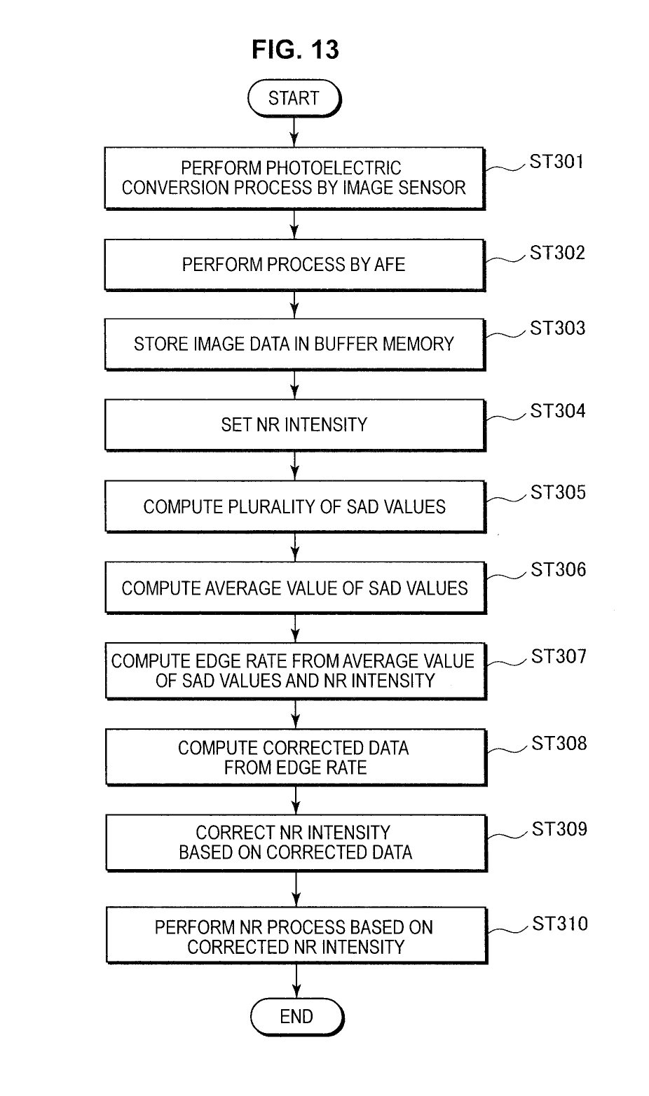

An example of the flow of a process performed in the image processing device 3 according to the third embodiment will be described with reference to the flowchart shown in FIG. 13. It should be noted that part of the process is performed by the image sensor or AFE of the imaging apparatus. In Step ST301, a photoelectric conversion process is performed by the image sensor 101 to acquire analog image data. Then, the process proceeds to Step ST302.

In Step ST302, the AFE 102 performs a process on the analog image data. From the process by the AFE 102, digital image data is obtained. Then, the process proceeds to Step ST303.

In Step ST303, the digital image data in a size necessary for processing is stored in the buffer memory 103. For example, image data of a block in the size of 7×7 pixels is stored in the buffer memory 103. Of course, the size of the block is not limited to the size of 7×7 pixels, and can be set to be an arbitrary size. Then, the process proceeds to Step ST304.

In Step ST304, an intensity of noise reduction is set by the noise reduction intensity setting unit 104. As described above, the noise reduction intensity setting unit 104 sets reference luminance information, and computes a variance σ(x) of noise using the reference luminance information, or the like. Then, the variance σ(x) of noise is multiplied by a predetermined intensity adjusting value S to compute a threshold value Th1. The threshold value Th1 is set as the intensity of noise reduction. Then, the process proceeds to Step ST305.

In Step ST305, a plurality of SAD values are computed by the SAD computing unit 201. The plurality of SAD values are supplied to the SAD average computing unit 202. Then, the process proceeds to Step ST306.

In Step ST306, the average value of the SAD values is computed by the SAD average computing unit 202. The average value of the SAD values is supplied to the edge rate computing unit 301. Then, the process proceeds to Step ST307.

In Step ST307, an edge rate is computed by the edge rate computing unit 301. The edge rate computing unit 301 performs a process for normalizing the average value of the SAD values using the threshold value Th1. The edge rate computing unit 301 divides the average value of the SAD values by, for example, the threshold value Th1 that is the intensity of noise reduction set by the noise reduction intensity setting unit 104. The edge rate computing unit 301 computes an edge rate according to the value computed in the normalization process. The edge rate is supplied to the corrected data computing unit 106. Then, the process proceeds to Step ST308.

In Step ST308, corrected data is computed by the corrected data computing unit 106. The corrected data computing unit 106 computes a magnification according to the edge rate, and supplies information indicating the computed magnification to the noise reduction intensity correcting unit 107. Then, the process proceeds to Step ST309.

In Step ST309, the intensity of noise reduction is corrected based on the corrected data. The noise reduction intensity correcting unit 107 corrects the intensity of noise reduction by multiplying the threshold value Th1 by the predetermined magnification to compute a threshold value Th2 that is the final intensity of noise reduction. The threshold value Th2 is supplied to the noise removing unit 204. Then, the process proceeds to Step ST310.

In Step ST310, the noise removing unit 210 performs a noise reduction process based on the threshold value Th2 that is the corrected intensity of noise reduction. Although not shown in the drawing, after Step ST310, a new pixel of interest is set, and the processes from Step ST304 to Step ST310 are repeated. When the processes are completed for all pixels of the image data, the process ends.

In the flow of the process exemplified in FIG. 13, some processes may be performed in parallel. For example, the processes of Step ST304, Step ST305, and Step ST306 may be performed in parallel.

### 4. Modified Examples

Hereinabove, the embodiments of the present disclosure have been described, but the present disclosure is not limited to the above-described embodiments, and can be variously modified. Hereinafter, a plurality of modified examples will be described.

### First Modified Example

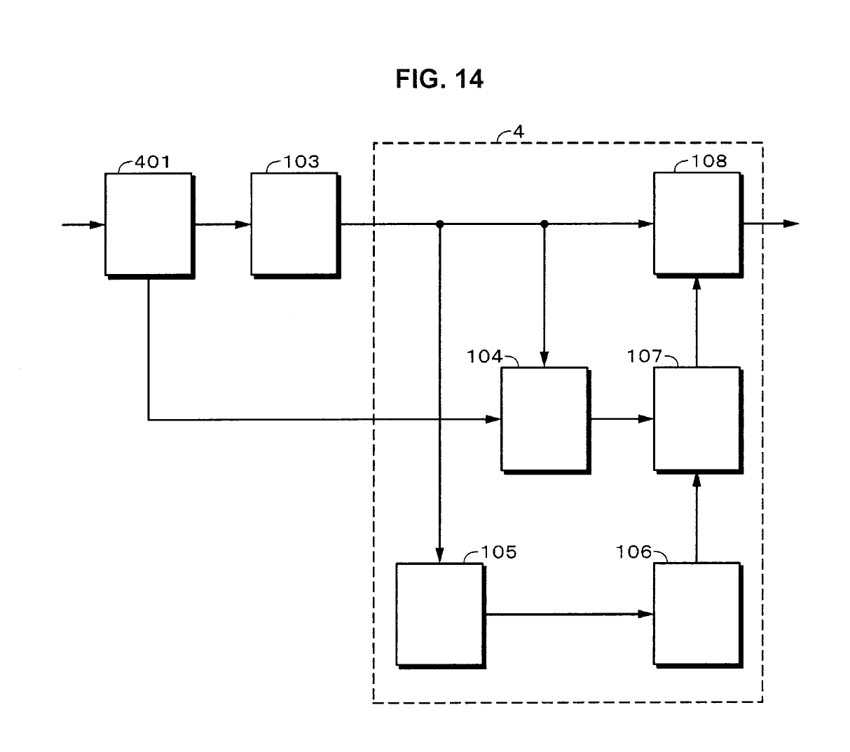

An image processing device according to the embodiment of the present disclosure does not necessarily have to be built in an imaging apparatus. For example, the image processing device may be configured as a part of a device such as a personal computer, or a smartphone. FIG. 14 is a diagram for describing a first modified example. In FIG. 14, the same reference numerals are given to the same portions as or the corresponding portions to those of the image processing device 1. Overlapping description of constituent elements to which the same reference numerals are given will be appropriately omitted.

Reference numeral 401 in FIG. 14 indicates an interface. Image data necessary for processes is acquired through the interface 401, and the acquired image data is written into the buffer memory 103. The image data acquired through the interface 401 is image data stored in a freely attachable or detachable memory, image data downloaded from the Internet, or the like. On the image data written into the buffer memory 103, for example, the same noise reduction process as performed in the image processing device 1 is performed.

The interface 401 is connected to the noise reduction intensity setting unit 104 of the image processing device 4. Information on a and b which are decided based on the characteristics of the image sensor is acquired from the interface 401, and the information is supplied to the noise reduction intensity setting unit 104. The noise reduction intensity setting unit 104 performs an arithmetic operation based on Equation 1 described above to compute a threshold value Th1 according to the information of a and b supplied from the interface 401 and reference luminance information x.

### Second Modified Example

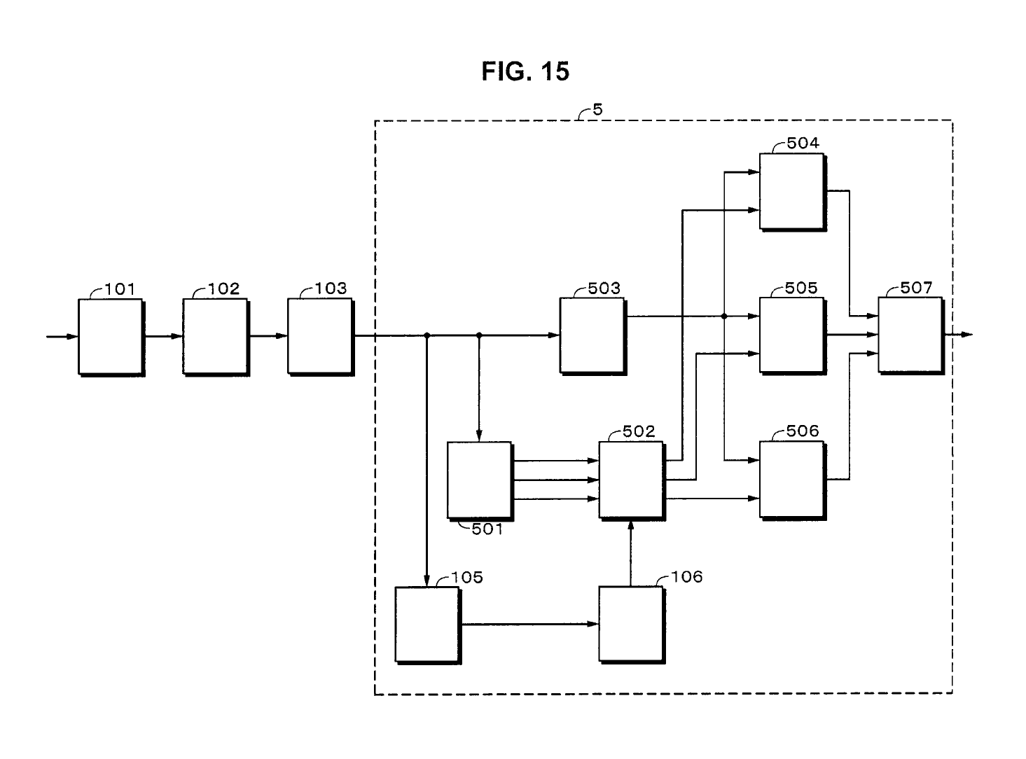

Image data may be divided for each predetermined frequency band, and a noise reduction process may be performed according to intensities of noise reduction set for each band. FIG. 15 is a diagram for describing an example of a configuration of an image processing device 5 according to a modified example. In FIG. 15, the same reference numerals are given to the same portions as or the corresponding portions to those of the image processing device 1. Overlapping description of constituent elements to which the same reference numerals are given will be appropriately omitted.

The image processing device 5 is configured to include a noise reduction intensity setting unit 501, a noise reduction intensity correcting unit 502, a band dividing unit (band dividing filter) 503, a noise removing unit 504, another noise removing unit 505, another noise removing unit 506, and a band combining unit 507 in addition to the edge rate computing unit 105 and the corrected data computing unit 106. Among the constituent elements, some may be included in the imaging apparatus, or constituent elements different from the exemplified ones may be added to the image processing device 5.

The noise reduction intensity setting unit 501 sets intensities of noise reduction for each band. For example, threshold values for each band are computed by changing the intensity adjusting value S in Equation 3 described above for each band. For example, a threshold value Th10 for a high frequency band, a threshold value Th20 for an intermediate frequency band, and a threshold value Th30 for a low frequency band are respectively computed. Each of the threshold values is supplied to the noise reduction intensity correcting unit 502.

The noise reduction intensity correcting unit 502 corrects each of the threshold values Th10, Th20, and Th30 based on the corrected data supplied from the corrected data computing unit 106. For example, a predetermined magnification supplied from the corrected data computing unit 106 is multiplies respectively by the threshold values Th10, Th20, and Th30.

A threshold value Th11 is computed by multiplying the predetermined magnification by the threshold value Th10. The threshold value Th11 is supplied to the noise removing unit 504. A threshold value Th21 is computed by multiplying the predetermined magnification by the threshold value Th20. The threshold value Th21 is supplied to the noise removing unit 505. A threshold value Th31 is computed by multiplying the predetermined magnification by the threshold value Th30. The threshold value Th31 is supplied to the noise removing unit 506.

The band dividing unit 503 divides image data stored in the buffer memory 103 for each frequency band. The band dividing unit 503 divides the image data into, for example, data for three frequency bands including a high frequency band, an intermediate frequency band, and a low frequency band. Of course, the image data may be more finely divided. The image data in the high frequency band is supplied to the noise removing unit 504. The image data in the intermediate frequency band is supplied to the noise removing unit 505. The image data in the low frequency band is supplied to the noise removing unit 506.

The noise removing unit 504 performs a noise reduction process based on the threshold value Th11. The noise removing unit 505 performs a noise reduction process based on the threshold value Th21. The noise removing unit 506 performs a noise reduction process based on the threshold value Th31.

The band combining unit 507 combines image data of each component that has undergone the noise reduction process by each of the noise removing units. In this manner, the intensities of noise reduction may set in the noise reduction processes for each band.

### Third Modified Example

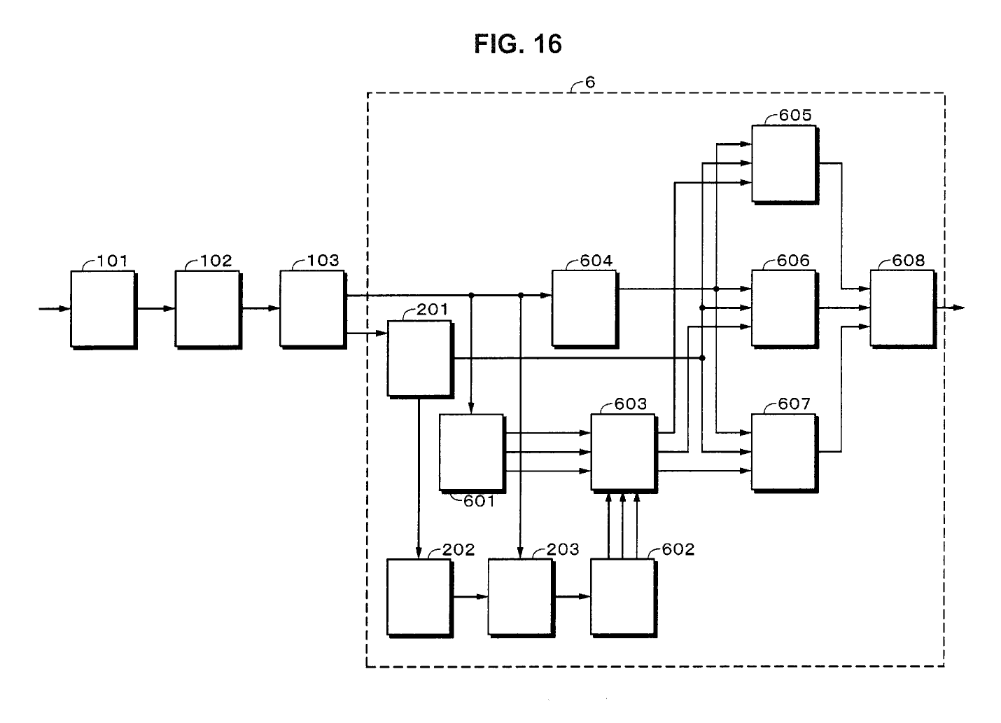

FIG. 16 shows an example of a configuration of an image processing device 6 according to a modified example. in FIG. 16, the same reference numerals are given to the same portions as or the corresponding portions to those of the image processing device 2. Overlapping description of constituent elements to which the same reference numerals are given will be appropriately omitted.

The image processing device 6 has a configuration in which the noise reduction process performed in the image processing device 2 is performed for each band. Furthermore, in the image processing device 6, corrected data may be generated for each band.

The image processing device 6 is configured to include a noise reduction intensity setting unit 601, a corrected data computing unit 602, a noise reduction intensity correcting unit 603, a band dividing unit (band dividing filter) 604, a noise removing unit 605, another noise removing unit 606, another noise removing unit 607, and a band combining unit 608 in addition to the SAD computing unit 201, the SAD average computing unit 202, and the edge rate computing unit 203.

The noise reduction intensity setting unit 601 computes threshold values Th10, Th20, and Th30 for each band in the same manner as the noise reduction intensity setting unit 501. The threshold values Th10, Th20, and Th30 are supplied to the noise reduction intensity correcting unit 603.

The corrected data computing unit 602 computes corrected data for each band according to the edge rate supplied from the edge rate computing unit 203. When the edge rate is high, for example, a magnification for a high frequency band is lowered. When the edge rate is lower than or equal to a threshold value, a pixel thereof may be regarded as a flat part, and one magnification may be set without discrimination for each band. As a magnification for a high frequency band, a magnification M1 is computed. As a magnification for an intermediate band, a magnification M2 is computed. As a magnification for a low frequency band, a magnification M3 is computed. The magnifications M1, M2, and M3 are supplied to the noise reduction intensity correcting unit 603.

The noise reduction intensity correcting unit 603 corrects the intensities of noise reduction by multiplying the magnifications which are examples of the corrected data by threshold values. The magnification M1 is multiplied by the threshold value M10 to compute a threshold value Th12. The threshold value Th12 is supplied to the noise removing unit 605. The magnification M2 is multiplied by the threshold value Th20 to compute a threshold value Th22. The threshold value Th22 is supplied to the noise removing unit 606. The magnification M3 is multiplied by the threshold value Th30 to compute a threshold value Th32. The threshold value Th32 is supplied to the noise removing unit 607.

The band dividing unit 604 divides the image data stored in the buffer memory 103 for each frequency band. The band dividing unit 604 divides the image data into, for example, data for three frequency bands including a high frequency band, an intermediate frequency band, and a low frequency band. Of course, the image data may be more finely divided. The image data in the high frequency band is supplied to the noise removing unit 605. The image data in the intermediate frequency band is supplied to the noise removing unit 606. The image data in the low frequency band is supplied to the noise removing unit 607.

The noise removing unit 605 performs a noise reduction process based on the threshold value Th12 and an SAD value supplied from the SAD computing unit 201. The noise removing unit 606 performs a noise reduction process based on the threshold value Th22 and an SAD value supplied from the SAD computing unit 201. The noise removing unit 607 performs a noise reduction process based on the threshold value Th32 and an SAD value supplied from the SAD computing unit 201.

The band combining unit 608 combines the image data of each of the components that have undergone the noise reduction processes by each of the noise removing units. In this manner, corrected data may be computed for each of the bands, and the intensities of noise reduction for each band may accordingly be corrected using the corrected data corresponding to each band. The processes performed in the image processing device 3 described in the third embodiment may be performed for each band.

### Another Modified Example

Another modified example will be described. In the embodiments described above, an SAD is used as an example of an evaluation value, but other evaluation values may be used. For example, an SSD (Sum of Squared Difference) that is the sum of squared differences between luminance values of pixels disposed in corresponding positions may be used as the evaluation value. However, as described above, when a process using an SAD is performed in an imaging apparatus, an edge rate can be computed using the SAD, and therefore, an SAD is preferably used as an evaluation value.

It should be noted that the configurations and the processes shown in the embodiments and the modified examples can be appropriately combined within the scope in which a technical contradiction does not arise. The orders of each of the processes in the exemplified processing flows can be appropriately changed within the scope in which a technical contradiction does not arise. Furthermore, the numerical values, objects, and the like shown in the embodiments and the modified examples are examples, and the present disclosure is not limited to the numerical values, and the like of the embodiments.

For example, the normalization process described in the third embodiment may be designed to be performed in the image processing device 2 of the second embodiment. The edge rate computing unit 203 of the image processing device 2 is connected to the line between the buffer memory 103 and the noise removing unit 204. For this reason, the edge rate computing unit 203 can obtain the luminance value of a pixel of interest. The edge rate computing unit 203 computes the square root of the luminance value of the pixel of interest. The normalization process may be designed to be performed by dividing the average value of the SAD values supplied from the SAD average computing unit 202 by the square root of the luminance value of the pixel of interest. The normalization process may be designed to be performed by computing the average (average luminance) of the luminance values of the pixel of interest and pixels in a predetermined block around the pixel of interest, and then dividing the average value of the SAD values by the square root of the average luminance.

The present disclosure can also be applied to a so-called cloud system in which the exemplified processes are performed by a plurality of devices in a distributed manner. The present disclosure can be realized as a system that executes the processes exemplified in the embodiments and the modified examples, which is a device that executes at least some of the exemplified processes.

Furthermore, the present disclosure is not limited to a device, and can be realized as a method, a program, or a recording medium. Such a program is stored in a memory included in an image processing device such as a ROM (Read Only Memory), or the like.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured below.

(1) An image processing device including:

a noise reduction intensity setting unit that sets an intensity of noise reduction for removing a predetermined noise component; and

a noise reduction intensity correcting unit that corrects the intensity of noise reduction based on corrected data obtained according to an edge rate.

(2) The image processing device according to (1), further including:

an edge rate computing unit that computes the edge rate based on a predetermined evaluation value.

(3) The image processing device according to (2), wherein the predetermined evaluation value is set based on an SAD (Sum of Absolute Difference) value between a first block set around a pixel of interest in a predetermined size and a second block set around a pixel different from the pixel of interest in a same size as the predetermined size.
(4) The image processing device according to (3),

wherein values of the SADs between the first block and a plurality of the second blocks are computed, and

wherein the predetermined evaluation value is a value obtained by averaging the plurality of the values of the SADs.

(5) The image processing device according to (4),

wherein the noise component has dependency on an input level of image data, and

wherein the predetermined evaluation value is obtained by normalizing the value obtained by averaging the plurality of values of the SADs in a manner that the dependency of the image data on the input level is cancelled.

(6) The image processing device according to (4), wherein, when the average noise amplitude with respect to an input level x of image data of the predetermined noise component is modeled with a following equation using a constant a corresponding to a noise component that has dependency on an input level of image data and a constant b corresponding to a noise component that does not have dependency on an input level of image data, the predetermined evaluation value is a value obtained by dividing the average of the values of the SADs by a value based on σ(x), or a value obtained by dividing the average of the values of the SADs by a value based on x.

σ(x)=\sqrt{ax+b}

(7) The image processing device according to any one of (1) to (6),

wherein the noise reduction intensity setting unit sets the intensity of noise reduction per band of image data, and

wherein the noise reduction intensity correcting unit corrects the intensity of noise reduction per band based on the corrected data.

(8) The image processing device according to any one of (1) to (6),

wherein the noise reduction intensity setting unit sets the intensity of noise reduction per band of image data, and

wherein the noise reduction intensity correcting unit corrects the intensity of noise reduction per band based on the corrected data per band obtained according to the edge rate.

(9) An image processing device including:

a noise reduction intensity setting unit that sets an intensity of noise reduction for removing a predetermined noise component;

an edge rate computing unit that computes an edge rate based on a predetermined evaluation value;

a noise reduction intensity correcting unit that corrects the intensity of noise reduction according to the edge rate; and

a noise removing unit that removes a noise component,

wherein the predetermined evaluation value is set based on a value of an SAD between a first block set around a pixel of interest in a predetermined size and a second block set around a pixel different from the pixel of interest in a same size as the predetermined size, and

wherein the noise removing unit removes a noise component based on the corrected intensity of noise reduction and the value of the SAD.

(10) An image processing method in an image processing device, the method including:

setting an intensity of noise reduction for removing a predetermined noise component; and

correcting the intensity of noise reduction according to an edge rate.

(11) A program for causing a computer to execute an image processing method in an image processing device, the method including

setting an intensity of noise reduction for removing a predetermined noise component, and

correcting the intensity of noise reduction according to an edge rate.

(12) An imaging apparatus including:

an imaging unit;

a noise reduction intensity setting unit that sets an intensity of noise reduction for removing a predetermined noise component;

a noise reduction intensity correcting unit that corrects the intensity of noise reduction based on corrected data obtained according to an edge rate; and

a noise removing unit that performs a noise reduction process on image data acquired through the imaging unit based on the corrected intensity of noise reduction.

The present disclosure contains subject matter related to that disclosed in Japanese Priority Patent Application JP 2012-163671 filed in the Japan Patent Office on Jul. 24, 2012, the entire content of which is hereby incorporated by reference.

What is claimed is:

1. An image processing device comprising:
a noise reduction intensity setting unit that sets an intensity of noise reduction for removing a predetermined noise component; and
a noise reduction intensity correcting unit that corrects the intensity of noise reduction based on corrected data obtained according to an edge rate.

2. The image processing device according to claim 1, further comprising:
an edge rate computing unit that computes the edge rate based on a predetermined evaluation value.

3. The image processing device according to claim 2, wherein the predetermined evaluation value is set based on an SAD (Sum of Absolute Difference) value between a first block set around a pixel of interest in a predetermined size and a second block set around a pixel different from the pixel of interest in a same size as the predetermined size.

4. The image processing device according to claim 3,
wherein values of the SADs between the first block and a plurality of the second blocks are computed, and
wherein the predetermined evaluation value is a value obtained by averaging the plurality of the values of the SADs.

5. The image processing device according to claim 4,
wherein the noise component has dependency on an input level of image data, and
wherein the predetermined evaluation value is obtained by normalizing the value obtained by averaging the plurality of values of the SADs in a manner that the dependency of the image data on the input level is cancelled.

6. The image processing device according to claim 4, wherein, when the average noise amplitude with respect to an input level x of image data of the predetermined noise component is modeled with a following equation using a constant a corresponding to a noise component that has dependency on an input level of image data and a constant b corresponding to a noise component that does not have dependency on an input level of image data, the predetermined evaluation value is a value obtained by dividing the average of the values of the SADs by a value based on σ(x), or a value obtained by dividing the average of the values of the SADs by a value based on x.
σ(X)=\sqrt{ax+b}

7. The image processing device according to claim 1,
wherein the noise reduction intensity setting unit sets the intensity of noise reduction per band of image data, and
wherein the noise reduction intensity correcting unit corrects the intensity of noise reduction per band based on the corrected data.

8. The image processing device according to claim 1,
wherein the noise reduction intensity setting unit sets the intensity of noise reduction per band of image data, and
wherein the noise reduction intensity correcting unit corrects the intensity of noise reduction per band based on the corrected data per band obtained according to the edge rate.

9. An image processing device comprising:
a noise reduction intensity setting unit that sets an intensity of noise reduction for removing a predetermined noise component;
an edge rate computing unit that computes an edge rate based on a predetermined evaluation value;
a noise reduction intensity correcting unit that corrects the intensity of noise reduction according to the edge rate; and
a noise removing unit that removes a noise component,
wherein the predetermined evaluation value is set based on a value of an SAD between a first block set around a pixel of interest in a predetermined size and a second block set around a pixel different from the pixel of interest in a same size as the predetermined size, and
wherein the noise removing unit removes a noise component based on the corrected intensity of noise reduction and the value of the SAD.

10. An image processing method in an image processing device, the method comprising:
setting an intensity of noise reduction for removing a predetermined noise component; and
correcting the intensity of noise reduction according to an edge rate.

11. A program for causing a computer to execute an image processing method in an image processing device, the method including
setting an intensity of noise reduction for removing a predetermined noise component, and
correcting the intensity of noise reduction according to an edge rate.

12. An imaging apparatus comprising:
an imaging unit;
a noise reduction intensity setting unit that sets an intensity of noise reduction for removing a predetermined noise component;
a noise reduction intensity correcting unit that corrects the intensity of noise reduction based on corrected data obtained according to an edge rate; and
a noise removing unit that performs a noise reduction process on image data acquired through the imaging unit based on the corrected intensity of noise reduction.
